(19) United States
(12) Patent Application Publication
(10) Pub. No.: US 2017/0254631 A1
(43) Pub. Date: Sep. 7, 2017

(54) HEIGHT MEASURING DEVICE

(71) Applicant: Cheng-Lung LEE, Yilan City (TW)

(72) Inventor: Cheng-Lung LEE, Yilan City (TW)

(21) Appl. No.: 15/447,194

(22) Filed: Mar. 2, 2017

(30) Foreign Application Priority Data
Mar. 2, 2016 (TW) 105202846

(51) Int. Cl. G01B 5/06

(52) U.S. Cl. CPC G01B 5/063

(57) ABSTRACT

The height measuring device is movably positioned on a scale surface, the height measuring device comprises: a bracket repeatedly attached to or detached from the scale surface; and a measuring unit assembled with the bracket, wherein the measuring unit includes a folding position and an extending position relative to the bracket, the measuring unit is close to the bracket in the folding position, and the measuring unit is perpendicular to the scale surface in the extending position. Then, it is convenient to accurately measure the height of users at kinds of objects with a scale surface.

### CROSS-REFERENCE TO RELATED APPLICATION

This application claims the priority benefit of Taiwan application Ser. No. 105202846, filed on Mar. 2, 2016. The entirety of the above-mentioned patent application is hereby incorporated by references herein and made a part of specification.

### BACKGROUND OF THE INVENTION

Field of the Invention

The disclosure relates to a measuring device and, more particularly, relates to a height measuring device.

Description of the Related Art

Conventionally, the height of a user can be read from a scale mark of a floor type height measuring device when the user stands thereon. The scale corresponds to the height from the bottom of feet to the upper of a head portion of the user. However, the height measuring device is large and expensive. Thus, the height measuring device is not easily configured at home. Consequently, users need to go the space with the height measuring device, such as a hospital, to have the measurement, which wastes time and money. Moreover, it is rather inconvenient for users who usually need to have the measurement, such as children.

### BRIEF SUMMARY OF THE INVENTION

A height measuring device including a bracket and a measuring unit is provided, and it is convenient to measure the height of users at kinds of objects with a scale surface.

According to an aspect of the invention, a height measuring device is provided. The height measuring device is movably positioned on a scale surface, the height measuring device comprises: a bracket repeatedly attached to or detached from the scale surface; and a measuring unit assembled with the bracket, wherein the measuring unit includes a folding position and an extending position relative to the bracket, the measuring unit is close to the bracket in the folding position, and the measuring unit is perpendicular to the scale surface in the extending position.

These and other features, aspects and advantages of the disclosure will become better understood with regard to the following embodiments and accompanying drawings.

### BRIEF DESCRIPTION OF THE DRAWINGS

FIG.1 is a schematic diagram showing a height measuring device in a first embodiment.

FIG.2 is an exploded diagram showing a height measuring device in a first embodiment.

FIG.3 is a schematic diagram showing a height measuring device in use in a first embodiment.

FIG.4 is a side view of a height measuring device in a first embodiment.

FIG.5 is an exploded diagram showing a height measuring device in a second embodiment.

FIG.6 is a side view of a height measuring device in a second embodiment.

FIG.7 is an exploded diagram showing a height measuring device in a third embodiment.

FIG.8 is a schematic diagram showing a height measuring device in a third embodiment.

FIG.9 is an exploded diagram showing a height measuring device in a fourth embodiment.

FIG.10 is a schematic diagram showing a height measuring device in a fourth embodiment.

FIG.11 is a schematic diagram showing a height measuring device in a fifth embodiment.

### DETAILED DESCRIPTION OF THE EMBODIMENTS

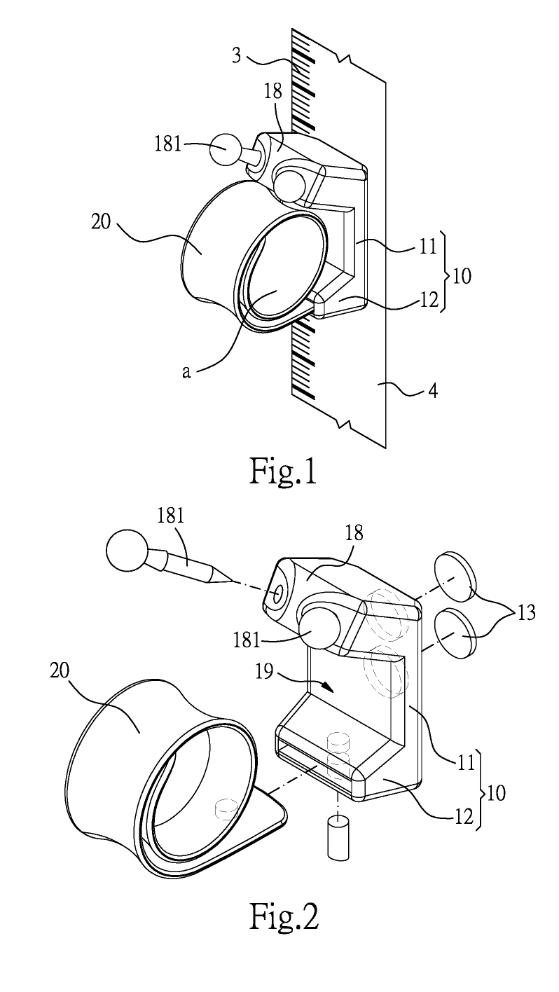

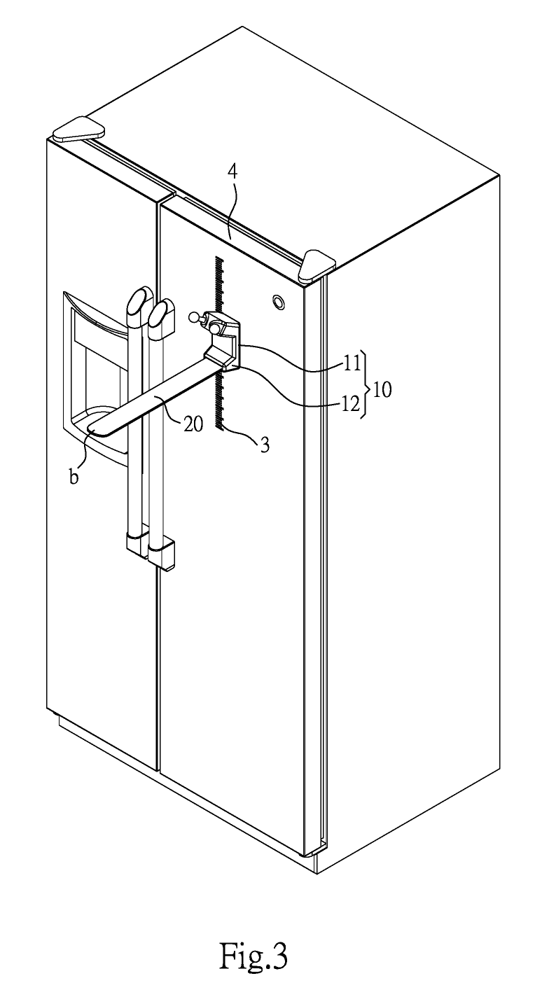

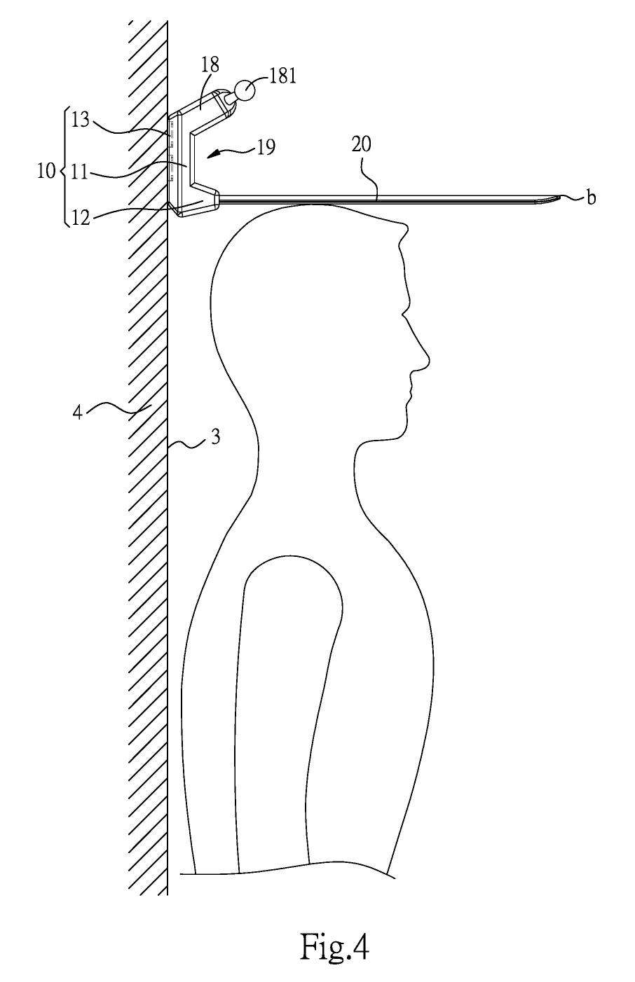

Please refer to FIG. 1 to FIG. 4, a height measuring device is movably positioned on a scale surface 3. In an embodiment, the scale surface 3 is a surface of the magnetic object 4. The magnetic object 4 is a refrigerator or a door, which is not limited herein. In an embodiment, the scale surface 3 is a surface of a non-magnetic object, such as a wall, a wardrobe, a bookcase. In an embodiment, a magnetic material, such as a ferrous sheet, is attached onto a surface of a non-magnetic object to make the surface of the non-magnetic object be magnetic. For example, a ferrous sheet is attached on a wall, or a height ruler with a ferrous sheet inside is attached on a wall of a wardrobe or a bookcase.

The height measuring device includes a bracket 10 and a measuring unit 20. The bracket 10 includes a support plate 11 and an extending plate 12 extending from the support plate 11. The support plate 11 includes at least a magnetic member 13 which can be repeatedly attached to the scale surface 3. Then, the support plate 11 is attached to or detached from the scale surface 3, or the support plate 11 moves on the scale surface 3 repeatedly.

The measuring unit 20 is assembled with the bracket 10. The measuring unit 20 includes a folding position a and an extending position b relative to the bracket 10. In the folding position, the measuring unit 20 is close to the bracket 10. In the extending position b, the measuring unit 20 is perpendicular to the scale surface 3. In the embodiment, the measuring unit 20 is a retractable tape. When the tape is retracted and close to the bracket 10, the measuring unit 20 is at the folding position a. When the tape extends far away from the folding position a, the measuring unit 20 is at the extending position b.

A head portion 18 is configured at a portion of the support plate 11 far away from the extending plate 12. An accommodation space 19 is formed between the head portion 18 and the extending plate 12. When the measuring unit 20 is retracted to the folding position, the measuring unit 20 locates in the accommodation space 19 (as shown in FIG.1 and FIG. 6). Additionally, the head portion further includes a pen 181. The pen 181 is detachably assembled with the head portion 18. In the embodiment, the pen 181 is used to mark the measured height on the scale surface 3. The pen 181 is convenient for recording the height, portable, and easily to be assembled.

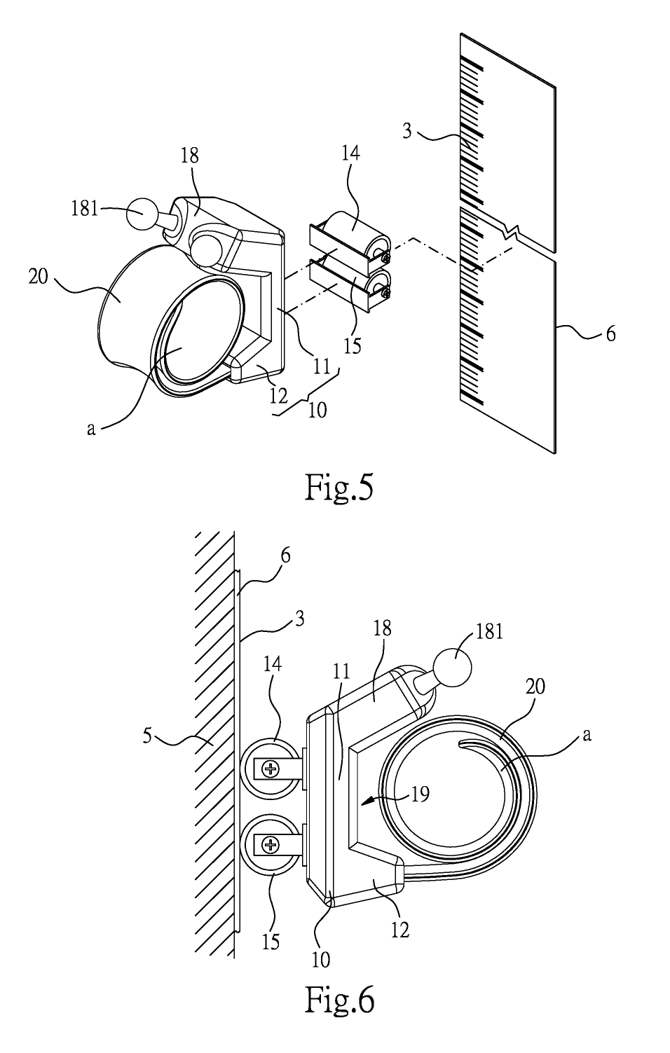

FIG. 5 and FIG. 6 show the height measuring device in a second embodiment. The height measuring device is movably positioned at the scale surface 3. In the embodiment, the scale surface 3 is a surface of a non-magnetic object 5. The non-magnetic object 5 is a door or a TV cabinet, which is not limited herein. Practically, a height gauge 6 with the scale surface 3 is attached to a surface of the non-magnetic object 5. Then, the scale for the height measurement is formed on the surface of the non-magnetic object 5. For example, the height gauge 6 made of paper is attached on a wall, or the height gauge 6 made of PVC is attached on the TV cabinet.

The height measuring device includes a bracket 10 and a measuring unit 20. The bracket 10 includes a support plate 11 and an extending plate 12 extending from the support plate 11. The support plate 11 includes a plurality of rollers 14 which moves on the scale surface 3 repeatedly. A sticky layer 15 formed at a surface of each roller is adhered with the scale surface 3. Then, the support plate 11 is detachable from the scale surface 3 repeatedly.

The measuring unit 20 is assembled with the bracket 10. The measuring unit 20 includes a folding position a and an extending position b relative to the bracket 10. In the folding position, the measuring unit 20 is close to the bracket 10 (as shown in FIG. 5). In the extending position b, the measuring unit 20 is perpendicular to the scale surface 3. In the embodiment, the measuring unit 20 is a retractable tape. When the tape is retracted and close to the bracket 10, the measuring unit 20 is at the folding position a. When the tape extends far away from the folding position a, the measuring unit 20 is at the extending position b.

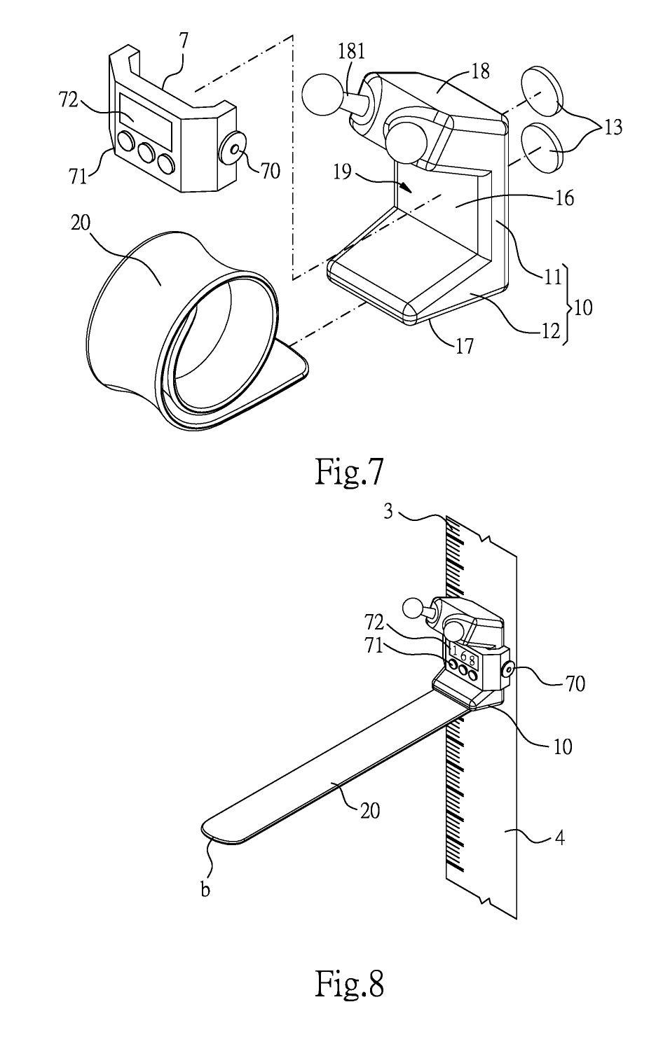

FIG. 7 and FIG. 8 show the height measuring device in a third embodiment. The height measuring device is movably positioned on a scale surface 3. In an embodiment, the scale surface 3 is a surface of a magnetic object 4, such as a refrigerator or a door. In an embodiment, the scale surface 3 is a surface of a non-magnetic object 4, such as a wall, a wardrobe, a bookcase. In an embodiment, a magnetic material, such as a ferrous sheet, is attached onto a surface of the non-magnetic object to make the surface of the non-magnetic object be magnetic. For example, a ferrous sheet is attached on a wall, or a height ruler with a ferrous sheet inside is attached on a wall of a wardrobe or a bookcase.

The height measuring device includes a bracket 10 and a measuring unit 20. The bracket 10 includes a support plate 11 and an extending plate 12 extending from the support plate 11. The support plate 11 includes at least a magnetic member 13 which is repeatedly attached to the scale surface 3. Then, the support plate 11 is adhered to the scale surface 3 repeatedly, or the support plate 11 moves on the scale surface 3 repeatedly.

The support plate 11 includes a first attachment face 16. The extending plate 12 includes a second attachment face 17. The measuring unit 20 is assembled with the second attachment face 17. The measuring unit 20 includes a folding position a (as shown in FIG. 5) and an extending position b relative to the bracket 10. In the folding position, the measuring unit 20 is close to the bracket 10. In the extending position b, the measuring unit 20 is perpendicular to the scale surface 3. In the embodiment, the measuring unit 20 is a retractable tape. When the tape is retracted and close to the bracket 10, the measuring unit 20 is at the folding position a. When the tape extends far away from the folding position a, the measuring unit 20 is at the extending position b.

In the embodiment, a rangefinder 7 is assembled on the first attachment face 16 of the support plate 11. In the embodiment, the rangefinder 7 is an electronical rangefinder. The rangefinder 7 is an optical rangefinder in another embodiment, which is not limited herein. The rangefinder 7 includes a counter wheel 70, a setting button 71, and a display screen 72. The counter wheel 70 is used to calculate the range moved up and down along the extending plate 12. The setting button 71 is used to set the rangefinder 7 to zero, or the setting button 71 is a power key. The display screen 72 is used to display the measuring result. In the measurement, the rangefinder 7 is placed at an original position. The setting button 71 is short pressed to make the rangefinder 7 record the original position. After the extending plate 12 moves up and down by an range, the counter wheel 70 calculates the moved ranged of the extending plate 12 based on the original position. Then, the measuring result is displayed on the display screen 72. After the measurement, the setting button 71 is long pressed to power off the rangefinder 7.

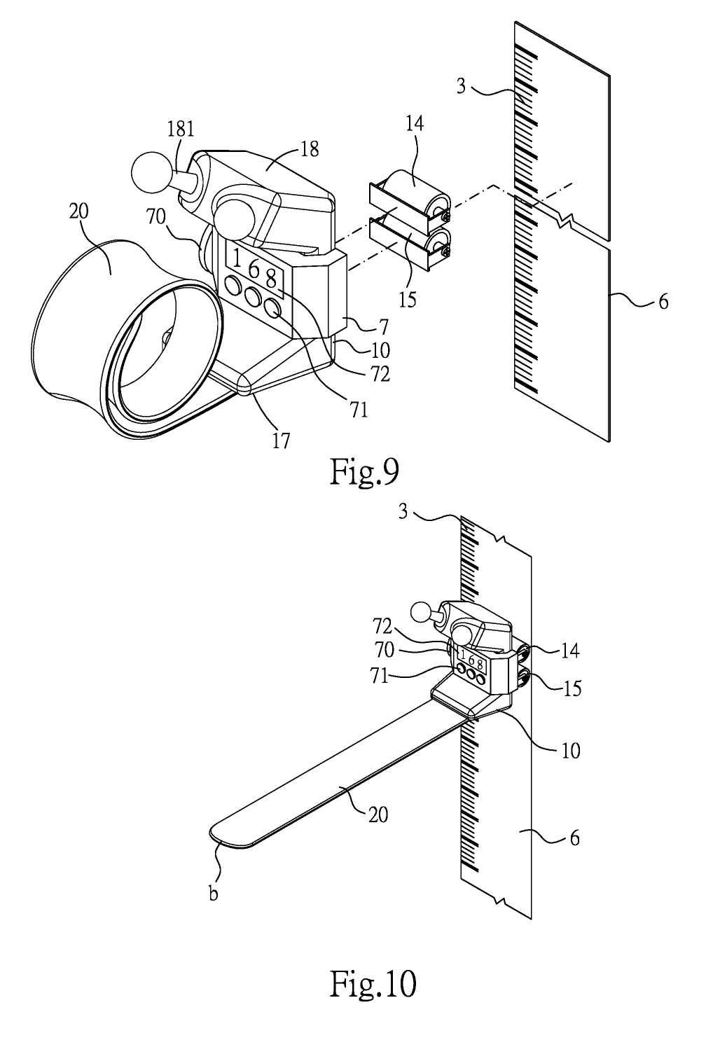

FIG. 9 and FIG. 10 show the height measuring device in the fourth embodiment. The height measuring device is movably positioned with the scale surface 3. In the embodiment, the scale surface 3 is a surface of a non-magnetic object 5. The non-magnetic object 5 is a door or a TV cabinet, which is not limited herein. A height gauge 6 with the scale surface 3 is attached to a surface of the non-magnetic object 5. Then, the scale for the height measurement is formed on the surface of the non-magnetic object 5. For example, the height gauge 6 made of paper is attached on a wall, or the height gauge 6 made of PVC is attached on the TV cabinet.

The height measuring device includes a bracket 10 and a measuring unit 20. The bracket 10 includes a support plate 11 and an extending plate 12 extending from the support plate 11. The support plate 11 includes a plurality of rollers 14 which moves along the scale surface 3 repeatedly. A sticky layerl5 is formed at a surface of each roller. Thus, the roller is adhered with the scale surface 3 repeatedly. Then, the support plate 11 is detachable from the scale surface 3 repeatedly.

The support plate 11 includes a first attachment face 16. The extending plate 12 includes a second attachment face 17. The measuring unit 20 is assembled at the second attachment face 17. The measuring unit 20 includes a folding position a (as shown in FIG. 5) and an extending position b relative to the bracket 10. In the folding position, the measuring unit 20 is close to the bracket 10. In the extending position b, the measuring unit 20 is perpendicular to the scale surface 3. In the embodiment, the measuring unit 20 is a retractable tape. When the tape is retracted and close to the bracket 10, the measuring unit 20 is at the folding position a. When the tape extends far away from the folding position a, the measuring unit 20 is at the extending position b.

In the embodiment, a rangefinder 7 is assembled on the first attachment face 16 of the support plate 11. In the embodiment, the rangefinder 7 is an electronical rangefinder. The rangefinder 7 is an optical rangefinder in another embodiment, which is not limited herein. The rangefinder 7 includes a counter wheel 70, a setting button 71, and a display screen 72. The counter wheel 70 is used to calculate the range moved up and down along the extending plate 12. The setting button 71 is used to set the rangefinder 7 to zero, or the setting button 71 is a power key. The display screen 72 is used to display the measuring result. In the measurement, the rangefinder 7 is placed at an original position. The setting button 71 is short pressed to make the rangefinder 7 record the original position. After the extending plate 12 moves up and down by an range, the counter wheel 70 calculates the moved ranged of the extending plate 12 based on the original position. Then, the measuring result is displayed on the display screen 72. After the measurement, the setting button 71 is long pressed to power off the rangefinder 7.

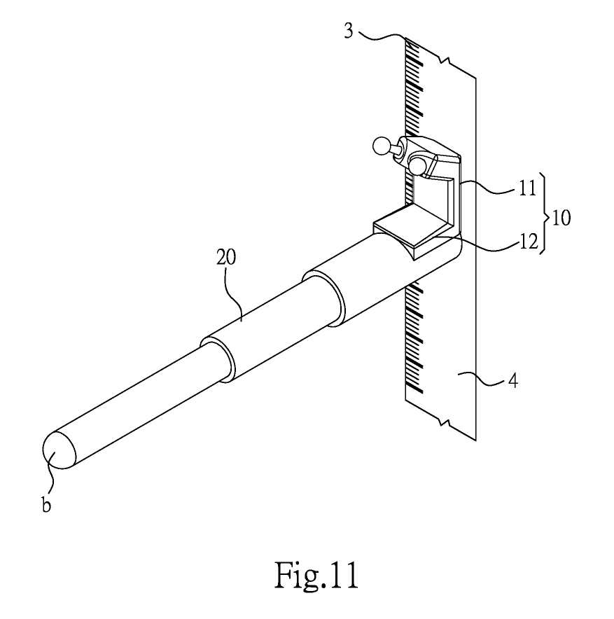

FIG. 11 shows the height measuring device in the fifth embodiment. The height measuring device is movably positioned on a scale surface 3. In an embodiment, the scale surface 3 is a surface of a magnetic object 4, such as a refrigerator or a door. In an embodiment, the scale surface 3 is a surface of a non-magnetic object 4, such as a wall, a wardrobe, a bookcase. In an embodiment, a magnetic material, such as a ferrous sheet, is attached onto a surface of the non-magnetic object to make the surface of the non-magnetic object be magnetic. For example, a ferrous sheet is attached on a wall, or a height ruler with a ferrous sheet inside is attached on a wall of a wardrobe or a bookcase.

The height measuring device includes a bracket 10 and a measuring unit 20. The bracket 10 includes a support plate 11 and an extending plate 12 extending from the support plate 11. The support plate 11 includes at least a magnetic member 13 which can be repeatedly attached to the scale surface 3. Then, the support plate 11 is adhered to the scale surface 3 repeatedly, or the support plate 11 moves on the scale surface 3 repeatedly.

The measuring unit 20 is assembled with the bracket 10. The measuring unit 20 includes a folding position a and an extending position b relative to the bracket 10. In the folding position, the measuring unit 20 is close to the bracket 10. In the extending position b, the measuring unit 20 is perpendicular to the scale surface 3. In the embodiment, the measuring unit 20 is a retractable rod. When the rod is retracted and close to the bracket 10, the measuring unit 20 is at the folding position a. When the rod extends far away from the folding position a, the measuring unit 20 is at the extending position b. In other embodiment, the measuring unit 20 has other types and structures, which is not limited herein.

In the embodiments, with the configuration of the height gauge 6, the bracket 10, and the measuring unit 20, the measuring unit can be applied to kinds of objects with the scale surface 3 and measure the height of users. Furthermore, cooperating with the rangefinder 7, the measurement is more accurate.

Although the disclosure has been disclosed with reference to certain embodiments thereof, the disclosure is not for limiting the scope. Persons having ordinary skill in the art may make various modifications and changes without departing from the scope of the disclosure. Therefore, the scope of the appended claims should not be limited to the description of the embodiments described above.

What is claimed is:

1. A height measuring device, movably positioned on a scale surface, the height measuring device comprising:
a bracket repeatedly attached to or detached from the scale surface; and
a measuring unit assembled with the bracket, wherein the measuring unit includes a folding position and an extending position relative to the bracket, the measuring unit is close to the bracket in the folding position, and the measuring unit is perpendicular to the scale surface in the extending position.

2. The height measuring device according to claim 1, wherein the bracket includes a support plate and an extending plate extending from the support plate, and the support plate moves on the scale surface repeatedly.

3. The height measuring device according to claim 2, wherein the support plate includes a plurality of rollers, a sticky layer is formed on a surface of each of the rollers, and the sticky layer is adhered with the scale surface repeatedly.

4. The height measuring device according to claim 2, wherein the support plate includes at least a magnetic member repeatedly attached to the scale surface.

5. The height measuring device according to claim 2, wherein the support plate includes a first attachment face, the extending plate includes a second attachment face, a rangefinder is assembled at the first attachment face, and the measuring unit is assembled at the second attachment face.

6. The height measuring device according to claim 5, wherein the rangefinder is an optical rangefinder.

7. The height measuring device according to claim 5, wherein the rangefinder is an electrical rangefinder.

8. The height measuring device according to claim 1, wherein the measuring unit is a retractable tape.

9. The height measuring device according to claim 1, wherein the measuring unit is a retractable rod.

10. The height measuring device according to claim 2, wherein a head portion is configured at a portion of the support plate far away from the extending plate, an accommodation space is formed between the head portion and the extending plate, and when the measuring unit is at the folding position, the measuring unit locates in the accommodation space.

11. The height measuring device according to claim 10, wherein the head portion includes at least a pen detachably assembled with the head portion, and the pen is used to mark on the scale surface.
